(19) United States
(12) Patent Application Publication
(10) Pub. No.: US 2009/0214837 A1
(43) Pub. Date: Aug. 27, 2009

(54) Insulating Label

(75) Inventors: Philip J. Albenice, Brunswick, GA (US); John F. Henderson, Floyds Knob, IN (US); Jean Donatelli, Cincinnati, OH (US); John W. Geurtsen, Holliston, MA (US)

Correspondence Address: WOOD, HERRON & EVANS, LLP, 2700 CAREW TOWER, 441 VINE STREET, CINCINNATI, OH, 45202, US

(73) Assignee: Multi-Color Corporation, Sharonville, OH (US)

(21) Appl. No.: 12/035,116

(22) Filed: Feb. 21, 2008

(51) Int. Cl. B32B 27/32; B32B 9/04; B32B 7/12; B32B 5/16; B32B 3/26; B32B 27/36

(52) U.S. Cl. 428/195.1; 428/411.1; 428/480; 428/523; 428/354; 428/304.4; 428/323; 428/537.5

(57) ABSTRACT

An insulating label, including a first layer, being a printable film layer; a second layer, being an insulating layer; and a third layer, being a lamination layer. The third layer may be disposed between the first layer and the second layer to operatively couple the first layer and the second layer. The insulating label may alternatively include a first layer, being a printable layer; and a second layer operatively coupled to the first layer and incorporating an expandable coating.

### FIELD OF THE INVENTION

The present invention generally relates to labels for application to various articles, such as bottles, cups, containers, etc., and more specifically relates to labels having insulating properties.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Articles that contain or can contain heated or cooled contents are known. These may include articles to which heated contents may be added, or articles that hold contents that may subsequently be heated within the article (or, alternatively, articles to which cooled contents may be added, or articles that hold contents subsequently cooled therein). As an example of the first type of container, vending machines may dispense hot drink, such as coffee, into cups made of paper, Styrofoam®, or other materials. Further, coffee houses may serve hot drinks in cups that may be wrapped with a protective sleeve, often made of paper or cardboard.

These articles, such as cups made of paper, Styrofoam®, or other materials (or those including sleeves of paper or cardboard), do not have sufficient insulation properties. If hot drink is contained in the cup, the cup gets hot. Particularly, in the case of a cup made of paper, the cup immediately gets hot, thereby making it difficult for a person to hold the cup in his or her hand. For those cups including sleeves, the heat is transferred through the sleeve and to the hand of the individual holding the cup. Further, the lack of adequate insulation results in the rapid cooling of the contents held within the article.

Other articles may include handles so that a person need not grip the side of the article. For example, some articles include a pair of handle portions made of paper, paperboard, or cardboard mounted on an outer surface of the article. The handle folds outwardly from the article to be held by a person. However, the handle portions must be raised from the body portion with the fingers of the person, which can be difficult. Further, if hot drink or the like is contained in the article without raising the handles, the body portion of the article gets hot, and the handle may get hot, as well. The hot drink also exerts a force on the portions of the article proximate the handle portions, such that they may fail and tear off the article. Finally, such an article does not include any insulating qualities that retard or prevent rapid cooling of the contents of the article.

As described above, other articles may hold contents that are designed to be heated in the article at a later time. For example, soup may be provided in closed packages, which a consumer heats in a microwave, and then eats or drinks directly from the article.

Such articles, like many consumer products, include labels attached to a surface of the article. However, the labels on these articles suffer the same defects as described above regarding the lack of adequate insulating properties. Thus, heat from the substance in the article is rapidly transferred to a person's hand. This makes the article uncomfortable to hold. Further, the substance inside the article may cool too quickly.

Additionally, many of the articles described above do not or cannot include labels of a type to provide label information to a consumer. This can result from the article being prepared from a material that is difficult to print on or attach a label to (such as Styrofoam® cups). Also, any such labels themselves do not provide adequate insulating properties.

Finally, the above-described articles are all used to contain hot substances or substances that are eventually heated. While insulated articles to contain cold or cooled substances also exist, they require an excessive amount of bulky materials, which results in high production time and costs.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

One aspect of the present invention includes an insulating label including a first layer, being a printable layer, and a second layer, being an insulating layer, which is coated to the first layer. The first layer may be a shrink film. Shrink films may include polyester, such as polyethylene terephthalate, and/or other polymers, including, but not limited to, polypropylene, polyethylene, polyvinyl chloride, oriented polystyrene, polyethylene terephthalate glycol, oriented polypropylene, or other polymer blends. The second layer may be an expandable layer. For example, the second layer may include a water-based dispersion with suspended microspheres therein. This second layer may be flood-coated to the first layer or may be applied in a pattern, such as by a printing cylinder. When the insulating label is applied to an article, the insulating layer (i.e., second layer) rests against an outside wall of the article, with the film layer (i.e., first layer) to the outside of the insulating layer (such that the outer side of the film layer would be grasped by an individual holding the article). The label may be applied around the article and then heated to be shrunk around, and thus operatively coupled to, the article by processes well known to those skilled in the art. During such processes, heat applied to the label may cause both expansion of the expandable coating of the second layer and result in shrinkage of the film of the first layer.

Such a label including a shrink film and an expandable coating is sufficient for application to an article for keeping contents of the article cool. Thus, the label is amenable for application to articles designed to be kept in a refrigerated section of a store. Such a label also includes insulating properties sufficient to keep warm contents of an article from cooling too rapidly.

In another aspect, the insulating label may include a first layer, being a printable nonshrink film, and a second layer, being an insulating layer that is coated to the first layer. Nonshrink films used for the first layer may include, but are not limited to, polyesters. The second layer may be the same as that described above with respect to the shrink film embodiment.

In yet another aspect, the second layer of the label may be a sheet-type or fabric-type layer (as opposed to a coating). Such a layer may include materials such as polyester, polyethylene, spun bound polypropylene, or other woven or nonwoven fibrous materials. This second layer may be associated with a first layer, being either a shrink film or a nonshrink film.

And another aspect of the present invention includes an insulating label including a first layer, being a printable film layer; a second layer, being an insulating layer; and a third layer, being a lamination layer. The third layer is disposed between the first layer and the second layer to operatively couple the first layer and the second layer. In particular, the label of this aspect of the present invention may include an extrusion as the third layer laminated to a nonwoven second layer.

Thus, in this aspect, the label may include first, second, and third layers of material adjacent to one another. These three layers may include polyester, polypropylene, and polyethylene, respectively. More specifically, the first layer is the outermost layer (i.e., the layer farthest from an article when the label is applied thereto), and may be a polyester film having an inner surface that may be printed with ink or inks. The ink may be reverse-printed to form the printed label information of the label when viewed from the nonprinted side of the film. (Alternatively, the outer surface of the film may be printed with ink or inks.) This first layer may also be coated with adhesive. The layer to the inside of the first layer (i.e., the “third layer”) may be an extrudate layer, which may include a thermal plastic extrudate. This layer may also include a titanium dioxide (TiO₂) additive, which provides a white pigment. Such a white pigment provides a visual backing for any inks, to enhance the appearance and readability of the text, graphics, designs, and other decorations of the label. The layer to the inside of the third layer (i.e., the “second layer”) may be a spun polypropylene nonwoven layer. This layer primarily provides the insulating properties of the label. Alternatively, this layer may be an expandable coating, as described above.

Thus, the third layer may be disposed between and associated with the second layer on one side, and the first layer on the other side. To combine the layers of the label, in one embodiment, the third layer, such as an extrudate layer may be extruded in a softened or molten form. As the third layer comes out of the extruder, it may be laid down onto an inside surface of the first layer, such as a polyester film. The second layer, such as a spun polypropylene nonwoven, may be laid down on the opposite side of the third layer. Once the three layers have contacted one another, they may be pressed and cooled (which solidifies the extrudate layer(s)).

Thus, the label includes multiple layers. Certain of those layers impart insulating properties, and certain of those layers allow printing of label information thereon. The label may be any of different types of labels. For example, the label may be a cut-and-stack label. Cut-and-stack labels, in general and as known to those skilled in the art, are prepared from label stock, cut to the particular shape of the final label product, and delivered to a customer for application to an article, such as a bottle, can, other container, etc. Alternatively, the label can be a roll-fed label. During application, the label is wrapped around and adhered to the container. This may be accomplished by use of an adhesive. The insulating properties imparted by the label maintain the temperature of contents in a container to which the label is applied (or at least slow the rate of temperature change), and prevent the transfer of heat (e.g., when the content temperature is hot) to the hand of a person holding the labeled container.

The label may be a nonshrink label, or alternatively a shrink label. And thus, various aspects of the present invention may include processes for applying such labels to articles. For example, articles may be delivered into a labeling unit and picked up by an in-feed star wheel or other mechanism. Labels are delivered to a labeling station. The speed of feed roller is adjusted to the required label length for continuous web tension. In a cutting unit, the labels are precisely cut. The labels then proceed to a hotmelt unit, where glue is applied to leading and trailing label edges. The label with the glue strip on its leading edge is then transferred to an article. This glue strip ensures an exact label positioning and a positive bond. As the article is rotated during label transfer, labels are applied tightly. Gluing of the trailing edge ensures proper bonding. Once the label is applied, the article is discharged.

Alternatively, the label may be a heat shrink label. Shrink films, such as shrink sleeves, are used in labeling, often as an alternative to pressure-sensitive labels, heat-transfer labels, and other labels (such as those that may be applied to articles as described above, with respect to nonshrink labels). Shrink labeling involves sizing a shrink film, which may be a tubular shrink sleeve, to a particular article. Then one shrinks the film to snugly wrap the article within the shrink sleeve. The shrinking process is generally accomplished by the application of heat or steam to the shrink sleeve. Further processing may include heat-sealing any unsealed portions of the shrink sleeve and/or covering the article contents with a shrink cover. The material used for shrink films, such as a shrink sleeve, may depend on the shape and weight of the article and its contents. The film has an inherent tension that is released by heating the film from the outside in a shrink oven. As the film cools, it shrinks snugly around the article. This shrinkage applies a very slight pressure to the article, which aids in holding the shrink film to the article.

Thus, the present invention contemplates several aspects covering several embodiments of insulating labels including, but not limited to, nonshrink films coated with an expandable layer, shrink films coated with an expandable layer, nonshrink films having a fabric layer laminated thereto, and shrink films having a fabric layer laminated thereto.

Various features discussed below in relation to one or more of the exemplary embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE FIGURES

Various features, aspects, and advantages of the present invention will become better understood when the following detailed description is read with reference to the accompanying figures in which like characters represent like parts throughout the figures, wherein:

FIGS. 1A-1D are cross-sectional views of various embodiments of an insulating label, in accordance with the principles of the present invention.

FIG. 2 is a cross-sectional view of the label of FIG. 1 applied to an article.

FIG. 3 is a bottom view of the label and article of FIG. 1, depicting the application of heat to apply the label to the article.

FIG. 4A is a cross-sectional view of an insulating flood coating on a label.

FIG. 4B is a cross-sectional view of an insulating patterned coating on a label.

FIG. 5 is a photograph magnified at 500× of a cross-sectional view of a label, in accordance with the principles of the present invention.

FIG. 6A is a schematic of a film useful in preparing a label, and having a roughened surface, in accordance with the principles of the present invention.

FIG. 6B is a cross-sectional view taken along line 6B-6B of FIG. 6A.

FIG. 7 is a schematic of application of a patterned insulating coating on a film via a gravure cylinder, in accordance with the principles of the present invention.

FIG. 8A is a schematic of a reticulated insulating coating for a label, in accordance with the principles of the present invention.

FIG. 8B is a cross-section of the label of FIG. 8A applied to an article.

FIG. 9A is a graph comparing insulating values of labels, in accordance with the principles of the present invention.

FIG. 9B is a diagram showing the heat transfer effects of an insulating label in accordance with the principles of the present invention.

FIG. 10A is a schematic of another embodiment of an insulating label in accordance with the principles of the present invention, including a lamination layer and an insulating layer.

FIG. 10B is a schematic of the construction of the label of FIG. 10A having a registered lamination layer and a registered insulating layer.

FIG. 11 is a schematic of Flexographic application of an adhesive coating to a film via a printing cylinder, in accordance with the principles of the present invention.

FIG. 12 is a schematic of a process of in-line die cutting of a registered insulating layer and matrix removal of a nonlaminated portion of an insulating layer.

FIG. 13 is a schematic of a matrix removal of a nonlaminated portion of an insulating layer.

FIG. 14 is a schematic of an exemplary apparatus used in the application of a shrink film insulating label to an article.

FIG. 15 is a schematic of an exemplary apparatus used in the application of a nonshrink film insulating label to an article.

### DETAILED DESCRIPTION OF EXEMPLARY EMBODIMENTS

One or more specific embodiments of the present invention will be described below. In an effort to provide a concise description of these embodiments, not all features of an actual implementation may be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Referring to the Figures, an insulating label 10 is provided. The insulating label 10 includes at least a first layer 12 positioned proximate to a second layer 14. As used herein, “proximate to” may mean “in direct contact with,” or “near, but not in direct contact with.” “Proximate to” also allows for intervening layers between the first and second layers. The first layer 12 may include a printable material, and the second layer 14 may include a material that imparts insulating properties to the label 10. To that end, the second layer 14 may be an expandable coating, for example. In one embodiment of an expandable coating, the second layer 14 may be a water-based dispersion having suspended microspheres therein, applied onto the first layer 12. In an alternate embodiment, the second layer 14 may be a sheet-type or fabric-type layer, such as a nonwoven layer, for example, positioned on the first layer 12. Such a sheet-type or fabric-type second layer 14 may be continuously bonded to the first layer 12 where the second layer 14 confronts the first layer 12. As used herein, a “coating” may refer to any second layer 14 formed, at least when applied, from a nonsolid substance. Such a substance could be liquid, emulsion, molten, extrusion, foam, or thixotropic, for example. And such substances may solidify once applied. As used herein, a “sheet-type” or “fabric-type” layer may refer to any second layer 14 that exhibits a solid form when applied, such that its state does not substantially change at ambient temperatures and conditions once applied.

Thus, a label in accordance with the principles of the present invention may include various films and various insulating layers include, but not limited to, a shrink film with a coated insulating layer, a shrink film with a fabric insulating layer, a nonshrink film with a coated insulating layer, and a nonshrink film with a fabric insulating layer.

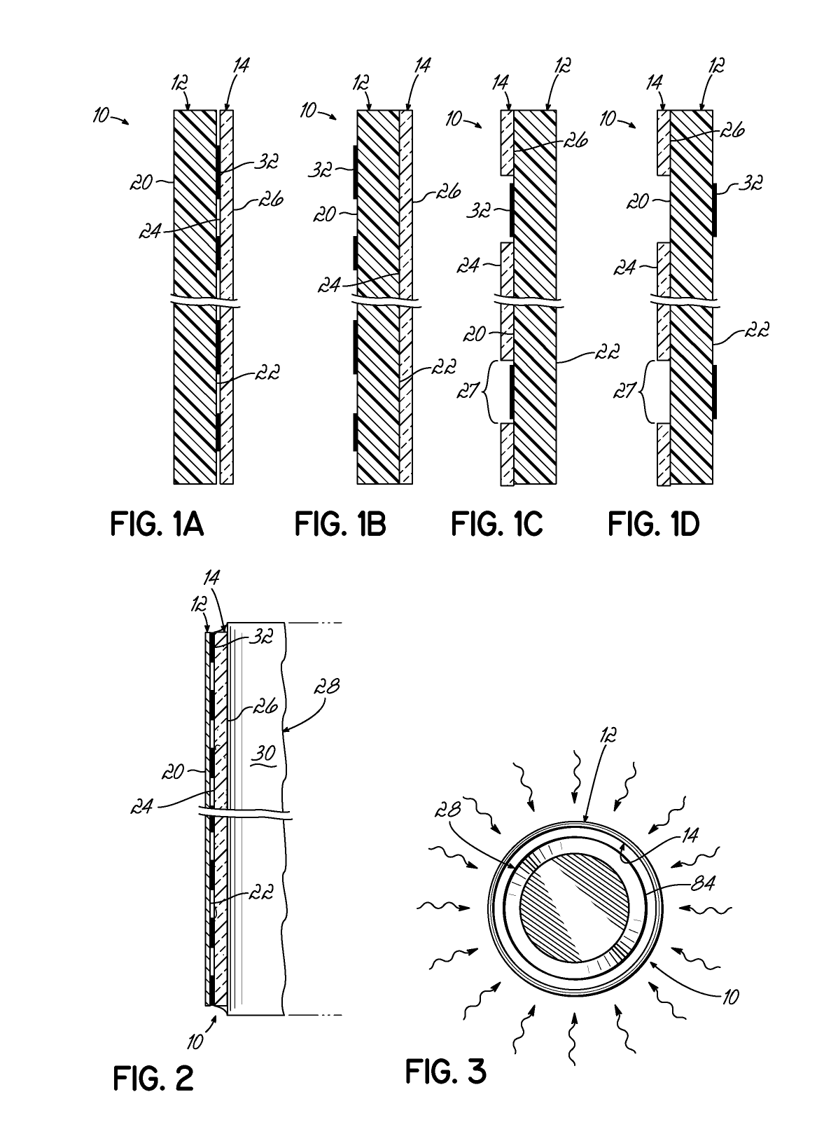

Referring now to FIGS. 1A-9B, an illustrated embodiment of an insulating label 10, and a process for its preparation, is shown. As shown in FIG. 1A, this embodiment of the insulating label 10 includes a first layer 12 having a first side 20 and a second side 22, and a second layer 14 disposed proximate to the second side 22 of the first layer 12. More specifically, the second layer 14 includes a first side 24 and a second side 26, with the first side 24 being positioned proximate to the second side 22 of the first layer 12. The first side 24 of the second layer 14 may directly contact at least a portion of the second side 22 of the first layer 12, or, alternatively, may merely be adjacent to and confront the second side 22 of the first layer 12, without direct contact. As shown in FIG. 2, when applied to an article 28, the second layer 14 and, particularly, the second side 26 thereof, confronts an outside wall 30 of the article 28, with the first layer 12 facing outwardly from the article 28 (such that the first side 20 of the first layer 12 would be grasped by an individual holding the article 28). Also, as shown in FIG. 2, in the illustrated embodiment, the second layer 14 has expanded and includes voids. This will be explained in greater detail below.

As described above, the first layer 12 may be formed from printable material. As such, the first layer 12 is amenable to receiving, on the first or second side thereof 20, 22, an ink layer 32 (which may include one or more inks and/or pigments) to provide text, graphics, and other decoration, such as may be found on labels 10. Such printable materials include, but are not limited to, paper and films, as is well known to those skilled in the art. In the illustrated embodiment, the first layer 12 is a printable film material. The film of the first layer 12 may be reverse-printed on the second side 22 thereof with the ink layer 32, such that text, pictures, graphics, and other decorations printed thereon may be viewed through the film (i.e., from the first side 20 of the first layer 12). The inks may be nitrocellulose inks. However, the inks of the label 10 are not necessarily limited to these particular inks and can be any inks known to those skilled in the art that are amenable for printing labels 10. The use of such reverse-printing on the second side 22 of the first layer 12 further results in the label information being protected from adverse forces subjected to the article 28 (e.g., the grip of a hand, scuffing, etc.). Alternatively, the first layer 12 may be printed on the first side 20 thereof.

While the embodiment illustrated in FIG. 1A shows a second layer 14 disposed proximate to the second side 22 of the first layer 12, those of ordinary skill in the art will recognize that other configurations of layers are possible. For example, as shown in FIG. 1B, the ink layer 32 (which may include one or more inks and/or pigments) may be positioned proximate to or received on the first side 20 of the first layer 12. In yet another embodiment, shown in FIG. 1C, the second layer 14 may be positioned relative to the first layer 12 such that the second side 26 of the second layer 14 is positioned proximate to the first side 20 of the first layer 12, with the ink layer 32 positioned proximate to or received on the first side 20 of the first layer 12. In order for the text, graphics, and/or other decoration of the ink layer 32 to be visible, the second layer 14 may further include an opening or openings, such as a “window” 27, in the second layer 14 that may conform to the shape of the ink layer 32. Finally, in yet another embodiment, depicted in FIG. 1D, the configuration of layers may be similar to that shown in FIG. 1C, except the ink layer 32 is positioned proximate to or received on the second side 22 of the first layer 12. As shown in FIG. 1D, the ink layer 32 is positioned in register with the openings 27 in the second layer 14. In the various embodiments shown in FIGS. 1A-1D, the interface of first and second layers 12, 14 (regardless of whether there is contact between those layers), are shown as having either first side 24 of second layer 14 proximate to second side 22 of first layer 12 (FIGS. 1A and 1B), or second side 26 of second layer 14 proximate to first side 20 of first layer 12 (FIGS. 1C and 1D). Regardless of the configuration of first and second layers 12, 14 to one another, one or more of the confronting sides, in certain embodiments, may have an adhesive property, to facilitate construction of the label 10.

The film of the first layer 12 may be a shrink film or a nonshrink film. One particular embodiment of the label 10 may include a shrink film as the first layer 12. Shrink films are well known to those skilled in the art. Shrink films may be chosen from materials including, but not limited to, polyester, such as polyethylene terephthalate, and/or other polymers including, but not limited to, polypropylene, polyethylene, polyvinyl chloride, oriented polystyrene, polyethylene terephthalate glycol, oriented polypropylene, or other polymer blends, for example. The shrink film may be oriented in the vertical direction or the horizontal direction. Or, the shrink film may be oriented in both the vertical direction and the horizontal direction. Thus, depending on the desired use, one may select a first layer 12 that, when subjected to heat, will shrink (1) in the vertical direction only, (2) in the horizontal direction only, or (3) in both the vertical direction and the horizontal direction. The choice of and use of such shrink films is well known to those skilled in the art.

As described above, the second layer 14 is an insulating layer. In one embodiment, the second layer 14 may be a coating that is sprayed or otherwise applied to the second side 22 of the first layer 12, and in certain particular embodiments, may be a reticulating coating, an expandable coating, a particle-dispersion coating, other coating formulation, or combinations thereof, as are known to those skilled in the art. The coating may be a solvent-based formulation, water-based formulation, electron-beam-curable formulation, or ultraviolet light-curable formulation, as are known to those skilled in the art. In a particular embodiment, the coating formulation may contain a dispersion of hollow spheres, ceramic spheres, or other particles having intrinsic insulating properties or postapplication-activated thermal properties. The coating formulation further may contain slip additives to aid in label sleeving and application.

Alternatively, the second layer 14 may be formed of a sheet-type or fabric-type material that is laid over and associated with the second side 22 of the first layer 12. Such materials may include, but are not limited to, foam, polyester, polyethylene, spun-bound polypropylene, other woven or nonwoven fibrous materials, or combinations thereof.

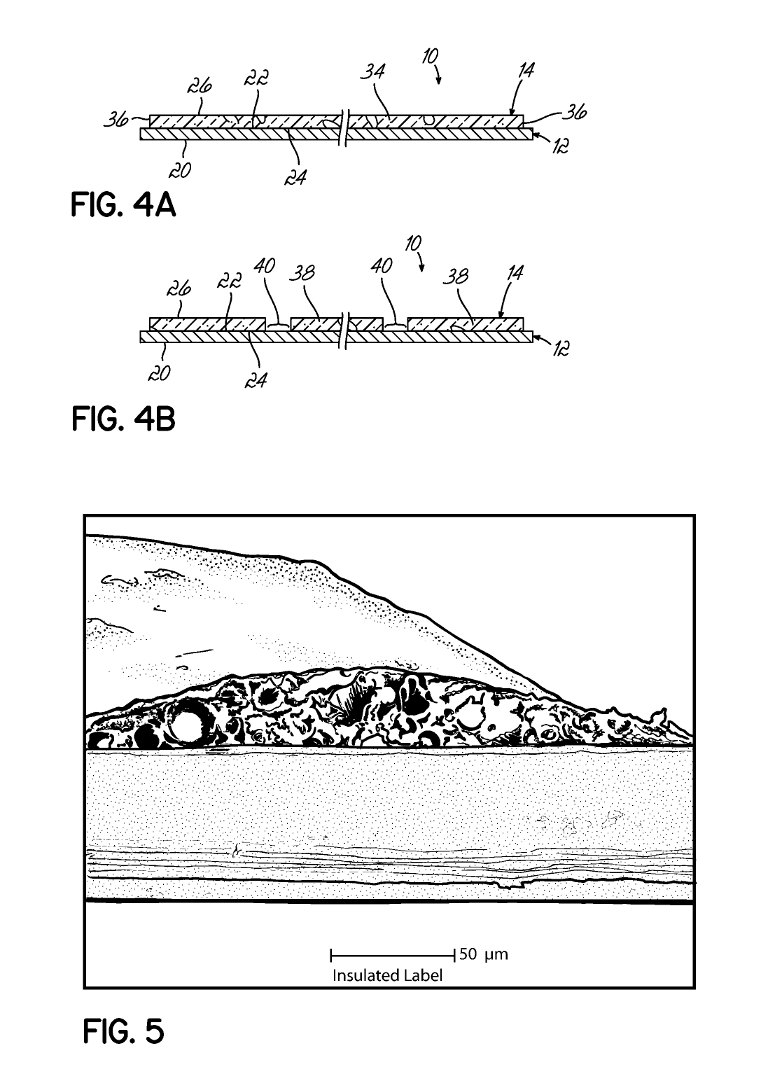

Referring now to FIG. 4A, the second layer 14 may be a coating 34, as described above, applied continuously against the second side 22 of the first layer 12. In such a continuous coating 34, the first side 24 of the second layer 14 confronts or contacts all or substantially all of the second side 22 of the first layer 12. In particular, as can be seen in FIG. 4A, a continuous coating 34 of the second layer 14 may cover substantially all of the second side 22 of the first layer 12. For example, the first layer 12 may extend beyond the border 36 of the second layer 14 on one side, or two diametrically opposed sides thereof. The first layer 12 extending beyond the border 36 of the second layer 14 may allow for a shrink film to be used as the first layer 12. As described above, such films may be oriented in one direction so they only shrink in one direction. Alternatively, such a continuous coating 34 may also be used with insulating labels 10 having a nonshrink film as the material of the first layer 12. As will be recognized by those skilled in the art, when the film of the first layer 12 is nonshrink, there is no need for the first layer 12 to extend beyond the borders 36 of the second layer 14, although it may so extend for seaming purposes. And thus, a label 10 having a continuous coating 34 may be amenable to use as roll-fed or cut-and-stack labels, for example.

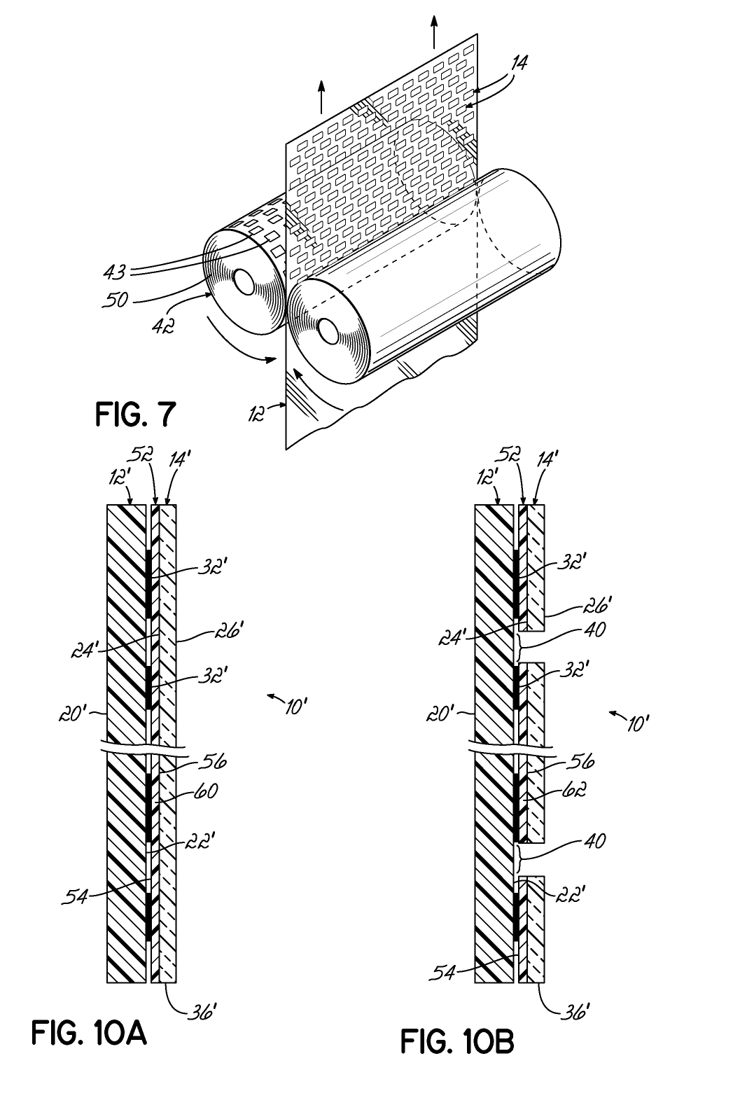

Alternatively, and referring now to FIG. 4B, the second layer 14 may be a coating, as described above, applied in a patterned form 38 against the second side 22 of the first layer 12. The application of the second layer 14 may be in a pattern that will be in register with the lay-flat requirements for label seaming (which are well known to those skilled in the art), or in register with any printing of the label 10. The coating may also be registered to leave uncoated areas 40 free for the label sleeving seam, fold, lay-flat, and high shrink requirements for label anchorage (which are well known to those skilled in the art) on the top and bottom of the article 28. The patterned form 38 of the coating may be achieved, in one embodiment, by engraving a gravure roll 42 (see FIG. 7) with the desired pattern of the coating, or by design of a screen mesh (not shown) or Flexographic printing plate (not shown) to the desired pattern of coating, as is well known to those skilled in the art.

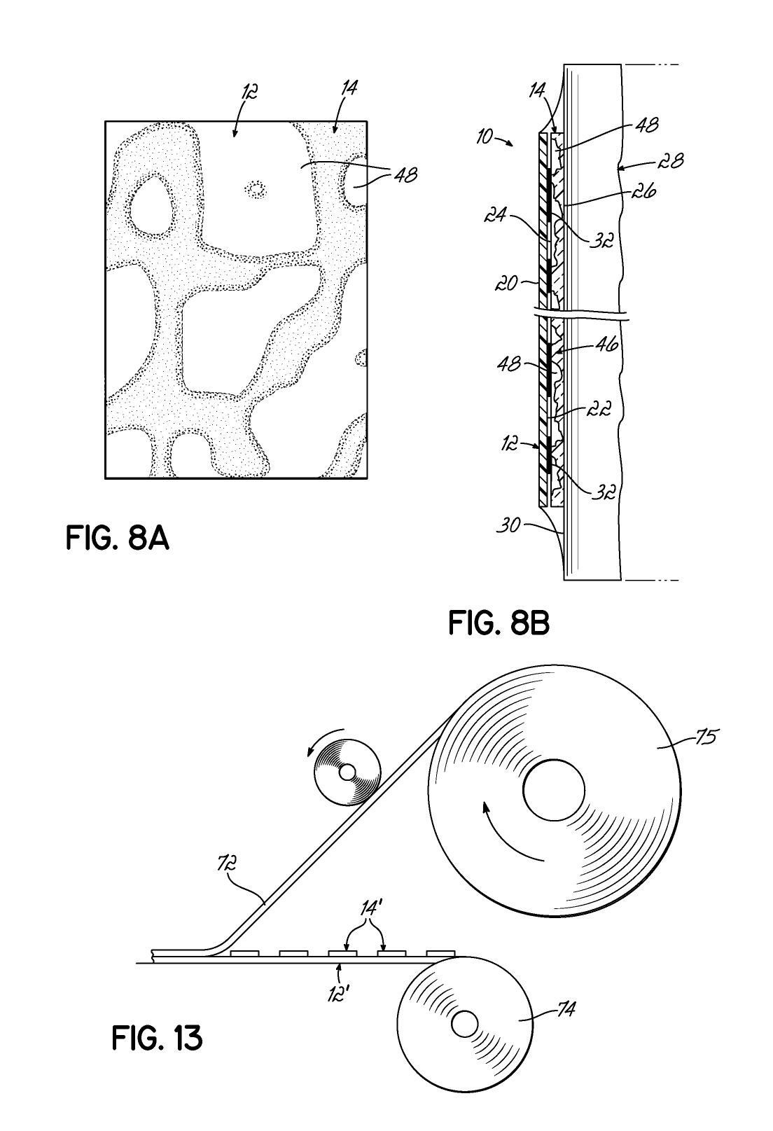

The insulating properties of the label 10 may be largely provided by voids 48 formed in the second layer 14. There are various ways that such voids 48 may be formed. In one particular embodiment, the coating, as described above, may be a reticulating coating 46 (as shown in FIGS. 8A and 8B, for example). The reticulating coating 46 can be continuously applied, or can be patterned, as described above. Such a coating 46, as known to those skilled in the art, can be activated to an exothermic reaction such that it expands. Thus, the coating 46 can achieve a “wormy-type” pattern on the second side 22 of the first layer 12 of film as it is cured by UV light. The coating 46 expands in a non-uniform fashion, having voids 48 therein. It is this non-uniform expansion that results in the “wormy-type” pattern, and the air-filled voids 48 enhance the insulating properties of the coating 46.

In another embodiment, the voids 48 may be provided by heat-activated microspheres. In particular, in this embodiment, the second layer 14 is a coating that is water-based, and includes an acrylic styrene base resin with microspheres blended therein. The coating has a total solid percentage in a range of about 47%-50%. The solids of the coating provide the insulating properties and rub resistance for the applied label 10. As is well known to those skilled in the art and as used herein, “rub resistance” is the resistance offered by the surface of a material to wear, resulting from mechanical action on the surface of the material.

The microspheres blended into the coating may be a polymeric shell filled with a blowing agent gas, such as isobutene or isopentane. The polymeric shell may be a copolymer of vinylidene chloride, acrylonitrile, and methylmethacrylate. Such microspheres are commercially available from suppliers such as Akzo Nobel, of Sundsvall, Sweden, and Roymal, of Newport, N.H. The microspheres are expanded by exciting the blowing agent with heat. In certain embodiments, a temperature of 190° F. may be used to initiate the blowing activation. FIG. 5 is a photograph of a label including such an expanded coating magnified 500×.

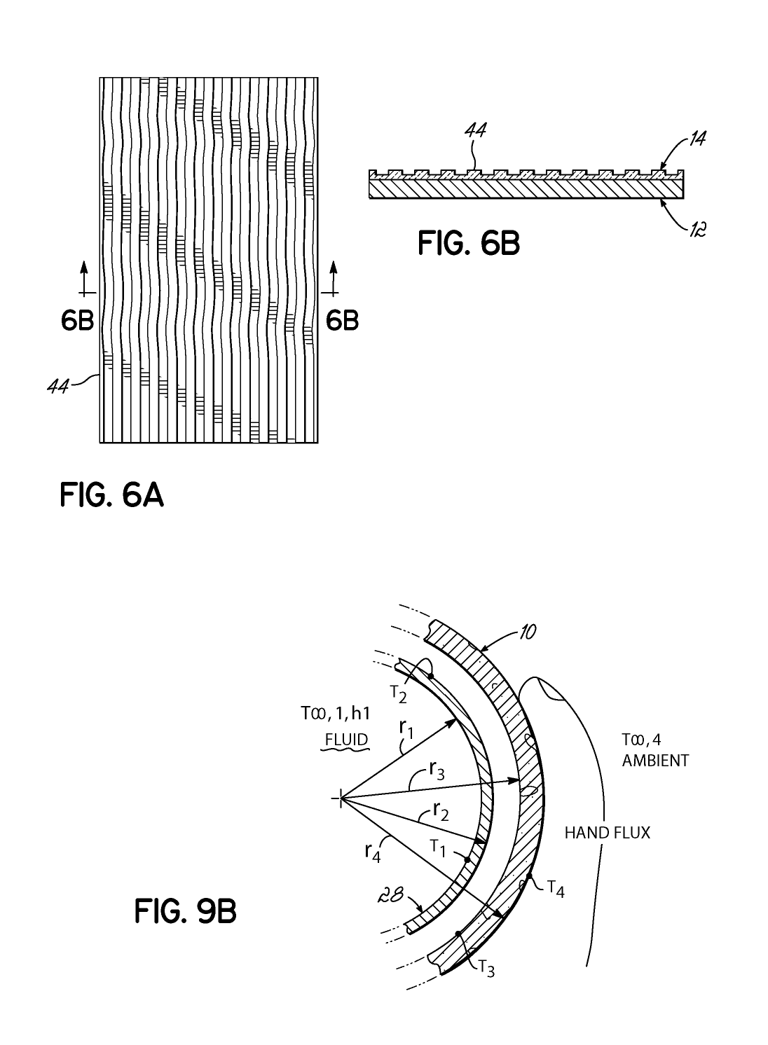

In a particular embodiment, the water-based encapsulated coating 16 may be applied with a 45-line screen cylinder with 80 μm-deep cells. This renders the second layer 14 as a rough pattern (denoted as 44 in FIG. 6). When applied against an article, the rough surface pattern creates a contact gap resistance (and turbulent air flow) such that the entrapped air promotes insulation. In one exemplary embodiment, the surface may have a roughness in the range of 110 to 150 Sheffield.

Prior to the application of heat, the heat-activatable, expandable, insulating second layer 14 is in a nonactivated, and thus nonexpanded, state. Referring to FIG. 7, the coating of the second layer 14 may be applied to the first layer 12 in an unexpanded state, via a gravure cylinder 42, to assure that the gravure etch cells 43 can achieve a capillary effect to the web (i.e., to the first layer 12). The coatings 16 may be applied in-line on a label printing press (not shown) or on a stand-alone coater (not shown). The coatings may be applied to the shrink label stock with conventional printing press equipment including, but not limited to, a direct gravure roll coater, Flexographic print unit, rotary or flat screen print unit, a slot die coater, or various other coating methods and apparatus. Coating weight and insulating properties are controlled by the gravure or anilox roll cell number and depth in gravure and Flexographic process, respectively, by screen mesh configuration in screen printing, and by other standard coater process controls.

Thus, the above-described methods for applying the coating include, but are not limited to, the use of printing cylinders, particularly for those for use in gravure printing. As is well known by those skilled in the art, such printing cylinders can be patterned either through mechanically engraving the cylinders or by chemically etching the cylinders. Alternatively, screen printing may be used for such patterned coating. Screen printing is a method well known to those skilled in the art.

The printing cylinder 50 is then used in printing the particular second layer 14 (i.e., insulative layer) of the illustrated embodiment of the insulating label. In general, a gravure printing unit for a rotary press includes a tray, which is filled with the coating. The printing cylinder, the peripheral surface of which has gravure cells for taking-up the coating, is mounted so that it rotates above and at least partially within the tray, in such a way that, as it is rotating, while the press is running, it dips into the material for the coating of the second layer, so that the gravure cells are filled with the coating. Substantially perpendicularly above the printing cylinder, an impression roller is mounted rotatably for rotating opposite to the direction of rotation of the printing cylinder. The impression roller, together with the printing cylinder, forms a roller gap therebetween, through which the film of the first layer, which is to be printed thereon with the patterned coating, is passed during operation of the press in order to take-up the coating from the peripheral surface of the printing cylinder in the desired pattern.

Thus, once the second layer 14 has been applied to the first layer 12 by use of a gravure cylinder 42, as in the illustrated embodiment, the second layer 14 may subsequently be exposed to heat in order to activate the second layer 14. When in a heat-activated state, the heat-activatable expandable second layer 14 expands to provide an insulating feature to the label 10. The application of heat may occur during the process of applying the label 10 to an article 28, although it may be applied prior to application of the label 10 to the article 28, or during a post-heating process. The heat-activatable, expandable, insulating second layer 14 may include various materials in order to achieve this expansion, and in a particular embodiment, includes a heat expandable composition including a binder resin and a solvent. The binder resin may be present in a range of about 50% by weight to about 80% by weight of the second layer 14, and the solvent may be present in a range of up to about 20% by weight of the second layer 14.

The solvent, such as water, for example, is used with an emulsifying agent to prepare an emulsion including the binder resin. This emulsifying agent may be a surfactant. In general, the binder resin is fragmentized, by methods well known to those skilled in the art. The fragmentized binder resin is then emulsified using the surfactant and solvent by methods also well known to those skilled in the art. The function of the binder is to impart cohesive film strength and interlayer adhesion within the label 10. Upon the application of heat, the expandable composition undergoes an expansive effect. This expansive effect can be disruptive to any other layers of the label 10. Thus, the binder resin is useful to hold any layers adjacent to the second layer 14 to one another in order to maintain the integrity of the label 10.

The heat-expandable composition of the second layer 14 may further be disposed on an outer surface of a plurality of microspheres (i.e., the microspheres are blended into the binder resin). These microspheres may be present in a range of about 10% by weight to about 50% by weight of the heat-activatable, expandable second layer 14. The microspheres are held together due to the binder resin of the expandable composition. The microspheres are designed to expand to allow expansion of the heat expandable composition upon the occurrence of a particular event, such as heating to a particular temperature. In order to expand, the microspheres may be constructed from an easily volatilizable hydrocarbon. In a particular embodiment, the microspheres may be constructed from Aqueous Suede Feel Coating formulation number 46909, commercially available from Roymal, of Newport, N.H. However, as will be recognized by those skilled in the art, the microspheres can be constructed from any material, as long as the microspheres can be adaptable to expand at the proper moment (such as due to a temperature) to result in expansion of the heat-activatable, expandable second layer 14. Additionally, the microspheres may include an interior compartment. A gas, such as isobutene or isopentane, for example, may be microencapsulated in the interior compartment encapsulated by the microspheres. The gas expands on the application of heat, causing the microspheres to expand and the associated composition to expand.

Thus, in one particular embodiment, the microspheres may be heat-activatable. In embodiments wherein the microspheres are heat-activatable, they may be adapted to expand at temperatures at or above about 180° F. When subjected to temperatures above about 180° F. during the process of attaching the label 10 to an article 28, the microspheres expand, and the composition expands, causing the second layer 14 to expand. The expandable second layer 14 is the only layer that expands when heated. In particular, the microspheres expand, releasing a gas, such as isobutane, which expands the coating. The material is then held in the expanded state by the binder resin. By using microspheres that are heat-activatable, the label 10 is useful when subjected to heat during the application process, such as shrink labels. This may eliminate the need for a separate heating step. However, it will be recognized by those skilled in the art that the heat-activatable expandable layer may be used for other types of labels, such as standard cut-and-stack or roll-fed labels.

The binder resin and solvent of the heat-activatable expandable second layer 14 may be chosen from various materials. For example, the binder resin may be chosen from acrylic binders, vinyl acrylic copolymer binders, vinyl acetate homopolymer binders, styrene acrylic binders, and phenoxy binders. More specifically, the acrylic binder may be selected from, but is not limited to, the following Rhoplex binder resins, commercially available from Rohm and Haas, of Philadelphia, Pa.: B15R, B60a, B85, B88, B959, GL618, GL623, HA12, P554, and SP100. Further, the vinyl acrylic copolymer binder may be selected from, but is not limited to, the following Polyco binder resins, commercially available from Rohm and Haas: 3103NP, 3250, and 6107. Further, the vinyl acetate homopolymer binder may be selected from, but is not limited to, the following Polyco binder resins, commercially available from Rohm and Haas: 2149A and 2152. Further, the styrene acrylic binder may be selected from, but is not limited to, the following binder resins, commercially available from Rohm and Haas: P308, P322, and P376. And finally, the phenoxy binder may be, but is not limited to, InChem PKHW34, commercially available from InChem Corporation, of Rock Creek, S.C.

The solvent may be chosen from any substance that is an efficient solvent for the heat-expandable composition, but which also does not cause the microspheres to expand. Thus, the solvent may be chosen from distilled water and isopropanol, for example.

The term “microencapsulated” or “microencapsulation” is to be taken to mean the packaging by encapsulation of certain liquids or solids in an enclosed shell. The walls of the microsphere must be chemically inert to the contents therein and must possess the required stability with respect to the surrounding medium. Further, the microspheres must be sealed and must be sufficiently fracture-resistant for the application in question, and also sufficiently temperature stable. The size of the microspheres depends on the production process and thus can be any size. In particular embodiments, the size extends from a diameter of about 2 microns to about a diameter of about 30 microns; however, a size of about 2 to about 20 microns is mostly used. In one embodiment, the microspheres may contain isobutane. The remaining expandable composition (i.e., binder, surfactant, and water emulsion) is coated on the outer surface of the microspheres. Upon the application of heat, the isobutane causes the microspheres to expand, thereby providing the expansive characteristic to the expandable composition.

The thickness of the second layer 14 is a function of the applied coat weight of the second layer 14. One may select a coat weight that will allow for a desired thickness once the coating is expanded (in the case of an expandable coating). Such a selection is routine and is well within the knowledge of those skilled in the art. In one particular embodiment, the insulating label 10 may include an applied coat weight of about 9.0 to 14.0 lb/ream, where a ream is 3000 ft². Such a 9.0 to 14.0 lb/ream coat weight will provide an expanded layer in the range of about 5.0 to 8.0 mm thickness.

Referring now to FIGS. 8A-8B, in an alternative embodiment (described briefly above), the second layer 14 may be a coating 46 that, because of induced surface tension differences, reticulates (de-wets) from the second side of the first layer 12. Thus, the second layer 14 forms a net-like or wormy-type pattern adjacent to the first layer 12. The reticulated coating may result in areas of differing thickness. Further, since the coating shrinks from the substrate surface, the coating lay-down cannot be controlled. By inducing reticulation, the coating forms voids 48 on the face material. The voids 48 (see FIG. 8B) may therefore be areas of noncontact with the outer wall of the article 28 after application. The voided areas form air pockets, which aid insulation.

The insulating label 10 can be provided as either a roll-fed shrink label or a shrink sleeve label. The roll-fed shrink film, also known as wraparound shrink to those skilled in the art, includes a shrinkable polymeric film. The wraparound film may be a uniaxially oriented film that has a dominant shrink in the machine direction of the film. The printed film is applied to the article 28 by a label-dispensing machine, such as is commercially available from Krones of Franklin, Wis.

When the insulating label 10 is applied as a roll-fed label and not as a sleeve label, the film may have no vertical shrink in the label 10. As shown in FIG. 3, the label 10 must conform in a horizontal direction around the article 28 where the applied label 10 shrinks, therefore creating hoop stress around the can.

The roll-fed shrink film seam differs from a shrink sleeve label in how the label is seamed. In a traditional shrink sleeve label, the label is seamed on a seamer at a converter and glued by a solvent bead that fuses two ends of the label. The roll-fed label is sent to the customer in a roll format and is seamed in the application process by using, for example, a hot-melt adhesive. This process is well known to those skilled in the art. Alternative methods well known to those skilled in the art may be used, as well, for example, other adhesives or ultrasonic seaming. A high-melt-point adhesive, such as can be commercially obtained from National Starch Adhesive, of Bridgewater, N.J., may be used to assure proper wet-out and flow of the adhesive to achieve a quality seam in magnitude of 50 to 130 grams/linear in. In either label process, the seamed label is then shrunk in a heat or steam tunnel. Generally, an infrared (“IR”) heat tunnel is used for this process because (1) a roll-fed shrink label generally requires a higher temperature than a steam tunnel can supply; and (2) an article, such as a can, generally has a low shrink demand in the range of 18%-25%. Further, a roll-fed shrink film is conducive to applying a heavy coating to the printed label 10, since the label 10 is not seamed into a tube or sleeve for application. Since the coating of the second layer 14 tends to have a high coefficient of friction, a roll-fed application reduces application and manufacturing issues.

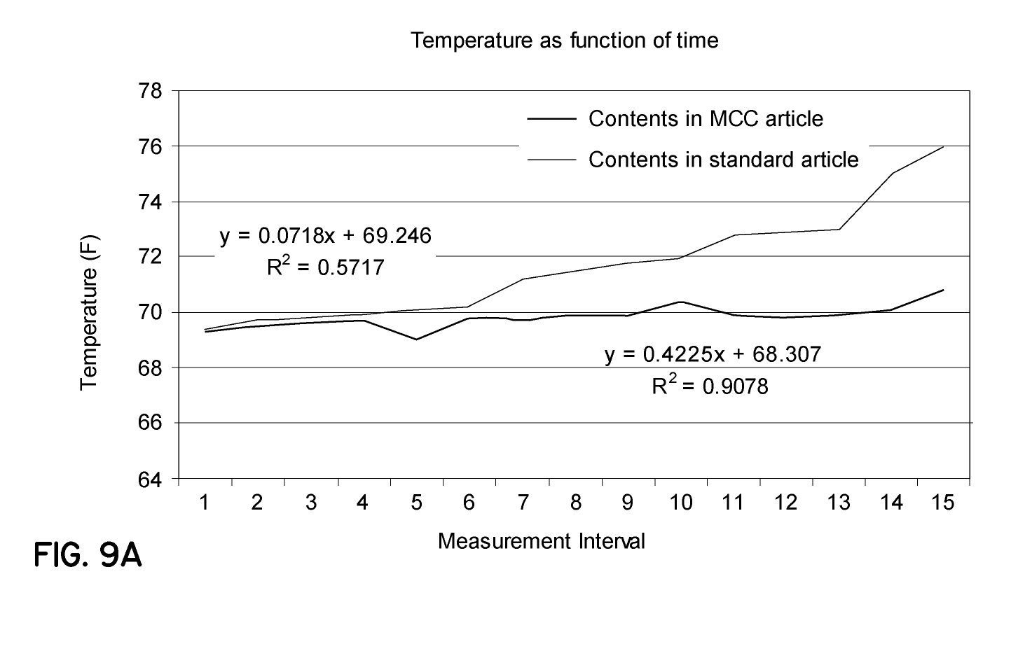

The embodiments of the insulating label 10 illustrated in FIGS. 1A-9 provides an insulating value, as shown in the plot illustrated in FIG. 9A. The plot illustrates the temperature of a chilled can subjected to a human grip over 600 seconds. The “X” axis of FIG. 9A shows measurement intervals (numbered 1 through 15). These correlate to the intervals of temperature measurements that were taken over those 600 seconds. An article 28 including a label 10, according to one aspect of the present invention, is denoted as “contents in MCC article” in the plot, and is compared to a product not including a label of the present invention, which is denoted as “contents in standard article.” In particular, the “standard can” of FIG. 9A includes a label that is not an insulating label. An embodiment of the label 10 of the present invention is associated with the “MCC can” of FIG. 9A. Further, FIG. 9A lists two equations: (1) y=0.4225x+68.307 (R²=0.9078) for the MCC can, and (2) y=0.0718x+69.246 (R²=0.5717) for the standard can. These are included because the temperature measurements of the can are measurements taken of a three-dimensional object. Thus, the equations are used to correlate those measurements to the two-dimensional graph of FIG. 9A (i.e., a graph having only “X” and “Y” axes, as opposed to “X,” “Y,” and “Z” axes). As can be seen from the graph of FIG. 9A, the MCC can, having an insulating label, fares much better than the standard can, in insulating against the change in temperature of the contents therein.

Referring now to FIGS. 10A-13, another aspect of the present invention provides an insulating label 10′ including a first layer 12′, a second layer 14′, and a third layer 52 disposed between the first layer 12′ and the second layer 14′ to operatively couple the first layer 12′ and the second layer 14′. In this embodiment, the first layer 12′ is a printable layer, and the second layer 14′ is an insulating layer. The third layer 52 may be an adhesive between the first and second layers 12′, 14′, such as may be provided by a laminating layer. The first layer 12′ includes a first surface 20′ and a second surface 22′. In use, the first surface 20′ of the first layer 12′ will be the surface that is farthest from an article 28 when the label 10′ is applied to an article 28. The second layer 14′ then, also includes first and second sides 24′, 26′, and the second side 26′ of the second layer 14′ will be the layer confronting, and perhaps contacting, the outer surface of an article 28 to which the label 10′ is applied. The third layer 52 includes a first side 54 and a second side 56, with the first side 54 confronting the second side 22′ of the first layer 12′, and the second side 56 confronting the first side 24′ of the second layer 14′.

As described above, the first layer 12′ is a printable layer. And so the first layer 12′ may include materials that can be printed, such as various films. Alternatively, paper may be used. In the illustrated embodiment, the first layer 12′ includes a film. Further, the insulating label 10′ may be of any type of label, such as a cut-and-stack label, a roll-fed label, a heat shrink label, a non-heat shrink label, etc. And so, the film of the first layer 12′ may include a shrink or nonshrink polymer, as may be needed to produce any such label that may be amenable to being used as a thermally insulating label 10. To that end, in certain embodiments of the label 10′, the film of the first layer 12′ of the illustrated embodiment may be chosen from polyester, polypropylene, polyethylene, polyvinyl chloride, oriented polystyrene, polyethylene glycol, and oriented polypropylene, for example.

As described above, the first layer 12′ of the label 10′ may be a printable film. And so, the label 10′ may further include an ink layer 32′. In certain embodiments, this ink layer 32′ may be adjacent the second side of the first layer 12′. Thus, the label 10′ includes a first layer 12′ including a first side 20′ and a second side 22′, and an ink layer 32′ adjacent said second side 22′ of said first layer 12′. The ink layer 32′ may be reverse-printed adjacent said second side 22′ of said first layer 12′ in certain embodiments. Further, the ink layer 32′ may include an adhesive.

In certain exemplary embodiments, an adhesive coating may also be applied on the second surface 22′ of the first layer 12′. This adhesive coating may be applied to assist in adhering the first layer 12′ to the second layer 14′, or to assist in adhering the first layer 12′ to the second laminating layer. In certain embodiments, the adhesive is continuously coated on the second side 22′ of the first layer 12′. In other embodiments, the adhesive is coated in a pattern on the second side 22′ of the first layer 12′. The particular adhesive that is used may be any adhesive known to those skilled in the art that is sufficient for fulfilling the function of an adhesive bonding two adjacent layers, such as polyester film and nonwoven layers, or polyester film and copolymer blended layers. The adhesive coating may be applied regardless of whether or not there is an ink layer 32′. The adhesive coating may be applied regardless of whether the third layer 52 is a laminating adhesive layer.

The second layer 14′ is an insulating layer, and thus includes material that imparts insulating properties to the label 10′. Such material, for example, may be a sheet-type or fabric-type material chosen from synthetic woven fibers, natural woven fibers, synthetic nonwoven fibers, natural nonwoven fibers, and foam. In a particular embodiment, the second layer 14′ includes a spun nonwoven polypropylene.

Referring now to FIG. 10A, the second layer 14′ may be continuously applied against the second side 22′ of the first layer 12′. As used herein, the second layer 14′ being applied “against” the first layer 12′ also allows for the ink layer 32′ and adhesive layer described above being between the first and second layers 12′, 14′. In such an application, the first side 24′ of the second layer 14′ confronts all or substantially all of the second side 22′ of the first layer 12′, at least indirectly (i.e., there may be a third layer 52 between the first and second layers 12′, 14′). Such a continuous application may be used with nonshrink-type labels. Since the film of the first layer 12′ is nonshrink, there is no need for the film to extend beyond the borders 36′ of the insulating layer, although it may do so for purposes such as the seaming of the label, for example. A label 10′ having such a flood application may be amenable to use as roll-fed or cut-and-stack labels.

Alternatively, the second layer 14′ may be applied in a patterned form, as in FIG. 10B, such that there are spaces including film of the first layer 12′ between adjacent portions of the second layer 14′.

The third layer 52, in certain embodiments, is a laminating layer that is used to laminate the first layer 12′ and second layer 14′ adjacent to one another. In certain embodiments, the third layer 52 is an extrudate layer. And thus, the third layer 52 is a lamination between the first layer 12′ and the second layer 14′. Thus, each of the first layer 12′ and the second layer 14′ includes first and second sides 20′, 22′, 24′, 26′, and the third layer 52 confronts the second side 22′ of the first layer 12′, and the first side 24′ of the second layer 14′.

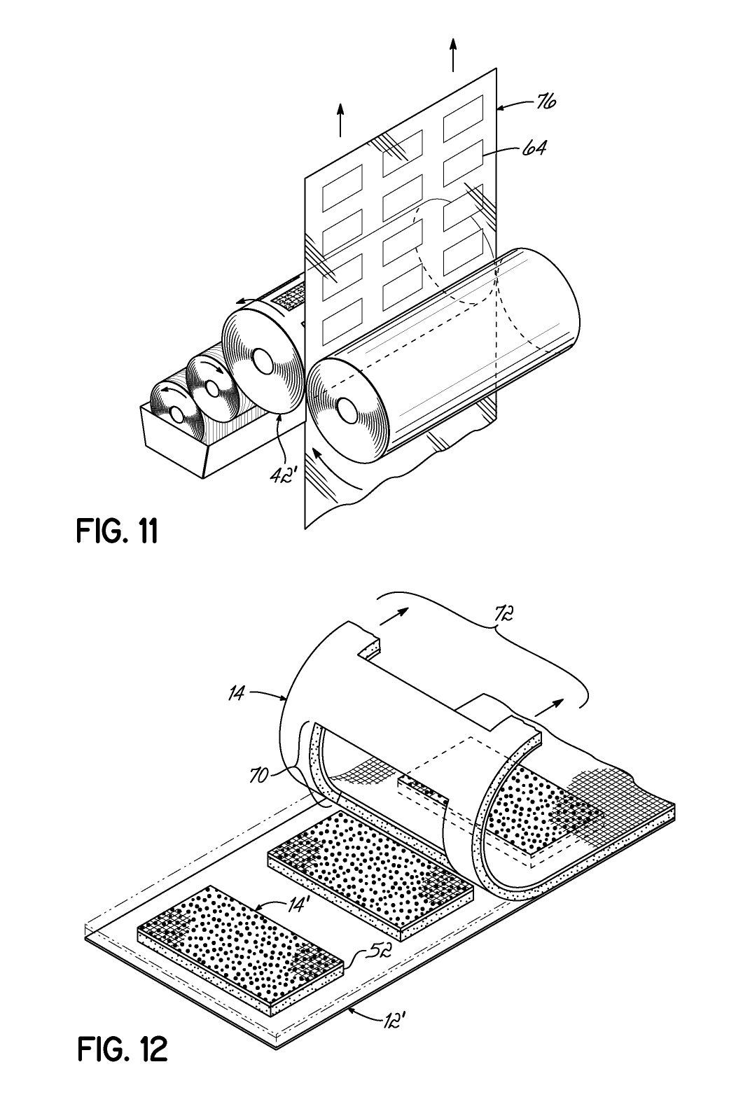

Referring again to FIG. 10A, the third layer 52 may be a coating applied continuously against the second side 22′ of the first layer 12′ (and thus also against the first side 24′ of the second layer 14′). As used herein, the third layer 52 being applied “against” the first layer 12′ also allows for the ink layer 32′ and adhesive layer described above being between the first and third layers 12′, 52. In such a continuous coating 60, the first side 54 of the third layer 52 confronts or contacts all or substantially all of the second side 22′ of the first layer 12′. Alternatively, and referring to FIG. 10B, the third layer 52 may be applied as a coating 62 in a patterned form, in register with the separate and adjacent registrations of the second layer 14′ (and thereby leaving uncoated areas 40 around the patterned coating). Registration of the third layer 52 may be achieved, in one embodiment, by engraving a gravure roll 42 (see FIG. 7) with the desired pattern of the coating, or by designing a Flexographic printing cylinder 42′ (see FIG. 11) or a screen mesh (not shown) to the desired pattern of coating. The second layer 14′ may be laid down on the second side 56 of this registered third layer 52, and any excess insulating material of the second layer 14′ may be die cut 70 and removed therefrom (see FIG. 12), as will be explained in greater detail below.

Thus, the third layer 52 may include materials that are suitable to laminate two adjoining material layers, as will be appreciated by those skilled in the art. Many polymers having such properties are well known to those skilled in the art. In one particular embodiment, the third layer 52 comprises a polymer blend, and in particular, comprises a blend of polyethylene and polypropylene. More specifically, the polymer blend may include about 30% low-density polyethylene (“LDPE”) and about 70% polypropylene.

The polymer blend of the third layer 52, as described above, may further include a titanium dioxide (TiO₂) additive. This additive provides a white pigment to the third layer 52. And thus, the white pigment provides a visual backing for the reverse-printed inks to enhance the appearance and readability of the text, graphics, designs, and other decorations of the label 10′.

The illustrated embodiment of the insulating label thus includes three layers of material adjacent to one another. These three layers may include polyester, polyethylene, and polypropylene. More specifically, in one exemplary embodiment, the outermost layer (i.e., the layer farthest from an article 28 when the label 10′ is applied to an article 28), being the first layer 12′, is a polyester film having an inner surface that may be printed with nitrocellulose gravure inks. The ink is reverse-printed to form the printed label information of the label 10′ when viewed from the nonprinted side of the polyester film. This polyester film may be coated with adhesive. The layer to the inside of the polyester film (i.e., the third layer 52) is an extrudate layer, which particularly may be an extrudate of low-density polyethylene (LDPE) and polypropylene. In one embodiment, the extrudate layer includes 30% LDPE and 70% polypropylene. This layer also includes a titanium dioxide (TiO₂) additive, which provides a white pigment. The white pigment provides a visual backing for the reverse-printed inks to enhance the appearance and readability of the text, graphics, designs, and other decorations of the label 10′. The second layer 14′, to the inside of the extrudate layer, is a spun polypropylene nonwoven layer. This second layer 14′ primarily provides the insulating properties of the label 10′.

The extrudate layer is disposed between, and bonded to, the spun polypropylene nonwoven layer on one side of the extrudate layer, and the polyester film on the other side. To combine the three layers of the label 10′, the extrudate layer comes out of an extruder (not shown) in a molten form. As the extrudate layer comes out of the extruder (not shown), it is laid down onto the second side 14′ of the first layer 12′ of polyester film that is unwinding off a roll. In particular, the extrudate layer is laid down on the “ink-side” surface of the polyester film. The spun polypropylene nonwoven unwinds from a separate roll and is laid down on the opposite side of the extrudate layer. Once the three layers have contacted one another, they are pressed and cooled (which solidifies the extrudate layer). The ink is an intervening substance between the polyester film and the extrudate layer, and the extrusion is bonded to the ink layer 32′ on one side, and the ink layer 32′ is bonded to the polyester layer on the other side (the ink includes an adhesive). And, the extrudate layer may completely coat the contacting surface of the nonwoven fibers of the second layer 14′, and insinuates in-between the fibers to a certain depth of the nonwoven layer.

Thus, the label includes multiple layers. Certain of those layers impart insulating properties, and certain of those layers allow printing of label information thereon. The label 10′ may be a cut-and-stack label. Cut-and-stack labels, in general and as known to those skilled in the art, are prepared from label stock, cut to the particular shape of the final label product, and delivered to a customer for application to an article 28, such as a bottle, can, other container, etc. Alternatively, the label 10′ can be a roll-fed label. During application, the label 10′ is wrapped around and adhered to the article 28. This may be accomplished by use of an adhesive. The insulating properties imparted by the label 10′ maintain the temperature of contents in an article 28 to which the label 10′ is applied (or at least slow the rate of temperature change), and prevent the transfer of heat (e.g., when the content temperature is hot or cold) to the hand of a person holding the labeled article 28.

Thus, this embodiment consists of an insulating layer of synthetic woven or nonwoven fiber materials laminated to the primary shrink face stock, as shown in FIGS. 10A and 10B. A laminating adhesive is used to bond the insulating layer to the back of the first layer 12′ of shrink face stock. If the face stock is reverse-printed, the insulating second layer is laminated to the ink layer on the back side of the first layer of face stock. The insulating second layer may be laminated to the shrink label stock, in FIG. 11, with a registered adhesive 64. The adhesive 64 is registered with a patterned etched gravure roll 42′ or patterned screen unit (not shown) or other coating method capable of coating in register. Registering the insulating layer leaves areas of the shrink label 76 available for seaming and unrestricted shrink.

Alternatively, and referring to FIGS. 12 and 13, lamination of the first, second, and third layers 12′, 14′, 52, may be done continuously, with any excess portions of the layers thereafter being die-cut and stripped away, leaving the label. For example, lamination may be performed in-line on a printing press (not shown) or by other coating methods. In such a process, the shrink label stock is adhesive coated using a patterned Flexographic printing plate in the last press section. The laminating adhesive may be a hot melt, reactive polyurethane, or any other adhesive appropriate for ensuring adequate bonding of the shrink face, and meeting the end use requirements. A secondary unwind section 66 feeds the insulating material into the laminating nip 68, where the tacky side of the adhesive coated label stock and insulating material are nipped together to form a layered construction. By registering or pattern-printing the adhesive (as shown in FIG. 11), the insulating material is laminated to the shrink label stock only where desired. Insulating material not laminated in register or printed adhesive is stripped from the face stock after being rotary die cut 70; and the waste matrix 72 is stripped. The laminated shrink label construction is wound into a roll 74.

FIGS. 12 and 13 provide details of the matrix removal and final label construction. The nonlaminated matrix is stripped from the label stock leaving the registered insulating material positioned as desired. The adhesive is patterned to accommodate the seaming operation or to leave the top and bottom left free of laminate for maximum shrinkage. The shrinkage of the nonlaminated label top and bottom helps to protect the insulating material from moisture and product incursion.

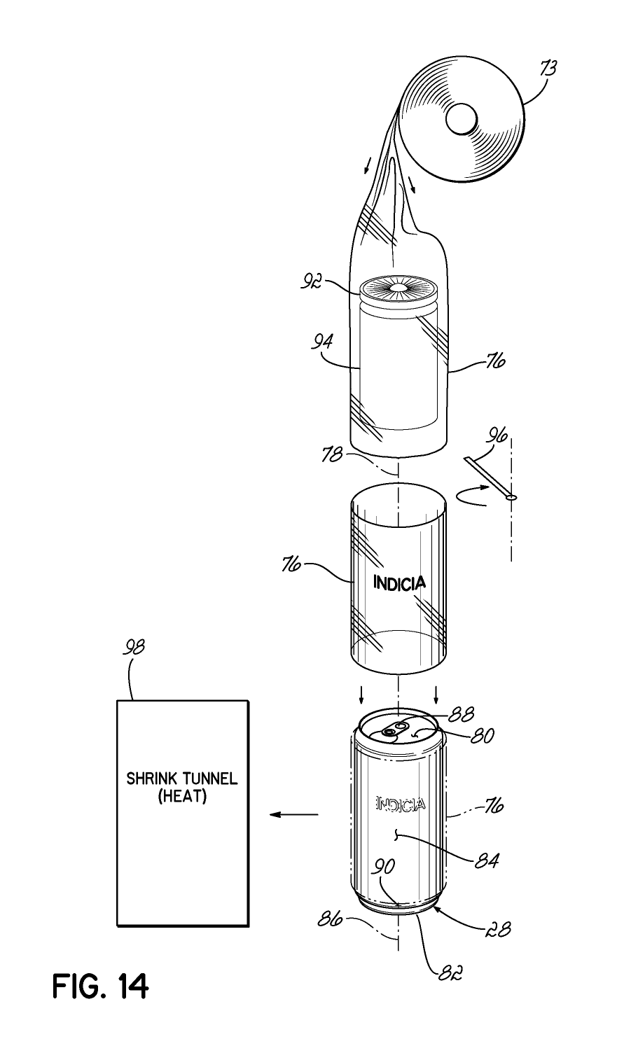

Labels of either the first or the second embodiments may then be applied to an article 28, such as a container. As described above, in certain embodiments, the label 10′ may be a shrink label. Referring now to FIG. 14, the present invention also provides a method for providing a shrink sleeve 76 over an article 28 such that, in use, the shrink sleeve 76 will not slip or tear away from the article 28 with which it is associated. This method includes the steps of first providing a shrink sleeve 76 generally as described above, which has an axis of symmetry 78.

The method of the present invention also includes providing an article 28 having a top end 80, a bottom end 82, a side surface 84, and a longitudinal axis 86 passing through a centerpoint 88 of the top end 80 and a centerpoint 90 of the bottom end 82. This article 28 is then oriented such that the longitudinal axis 86 of the article 28 is substantially parallel to the axis of symmetry 78.

Next, the shrink sleeve 76 is positioned over and around the article 28 such that at least a portion of the side surface 84 of the article 28 is disposed within and substantially surrounded by the shrink sleeve 76. Finally, the shrink sleeve 76 is shrunken such that the inner surface of the shrink sleeve 76 constricts around a portion of the side surface 84 of the article 28.

Additionally, the method includes severing the shrink sleeve 76 between articles 28 to separate them into individual shrink sleeves 76, each associated with one such article 28. In one particular embodiment of the invention, the shrink sleeves 76 are heat-shrunken on the articles 28 using hot air in a shrink tunnel 98, through which the articles 28 and associated shrink sleeve films are moved.

In the illustrated embodiment of the present invention, the shrink sleeve apparatus includes a roll 73 from which the shrink sleeve 76 is dispensed, an air source 92, a mandrel 94, a cutoff device 96, and a shrink tunnel 98. An article 28, such as a bottle, is then guided underneath the air source 92 and mandrel 94. A shrink sleeve is blown open by air from the air source 92 and is then slipped over the mandrel 94 and over the article 28. (The articles 28 are positioned such that the longitudinal axis 86 of each article 28 is substantially parallel to the axis of symmetry 78 of the shrink sleeve 76.) After the shrink sleeve 76 is positioned around the article 28, a cutoff device 96 is used to sever the shrink sleeve 76 from the remainder of the roll 73. Next, the article 28 and the loose plastic shrink sleeve 76 proceed through the shrink tunnel 98, which shrinks the shrink sleeve 76 against the article through the application of heat. In one embodiment, heat may be applied to the shrink sleeve 76 and article 28 at a temperature in the range of about 140° F. to about 190° F. Following shrinking, the article 28 and shrink sleeve 76 may then be cooled. Such a shrink sleeve apparatus is commercially available from Nippon Automatic Fine Machinery Company of Anaheim Hills, Calif.

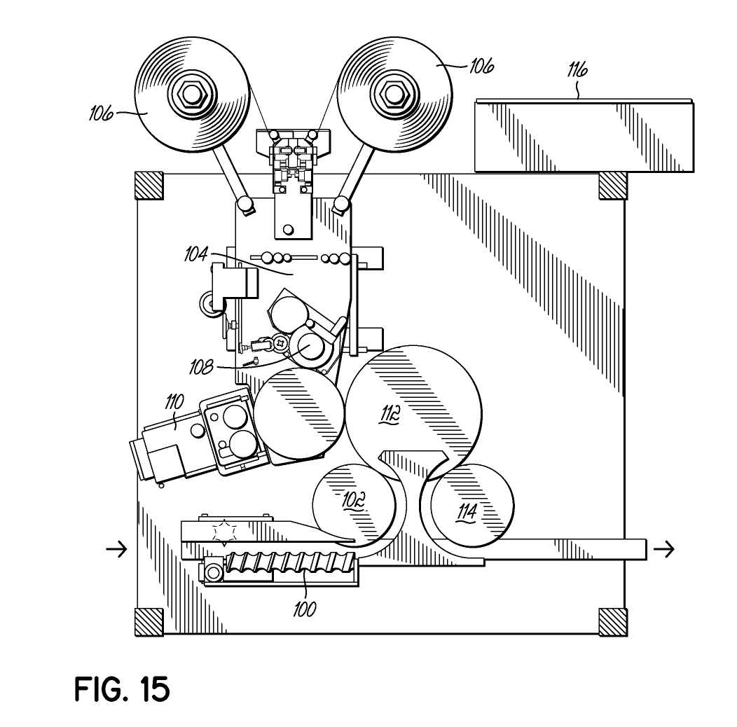

Alternatively, an insulating label may be a nonshrink label, and may be applied to an article. Referring now to FIG. 15, in one particular illustrated embodiment, the label 10 of the present invention may be applied to an article 28 as follows. Articles delivered into a labeling unit by an infeed worm 100 and are picked up by an in-feed star wheel 102 to be transferred to an article table 112. Article rotation then begins when the articles 28 are positioned between article plates and centering bells.

The labels 10 are delivered via label reels 106 to a labeling station 104. The speed of the a feed roller is adjusted to the required label length for continuous web tension. A standard threading unit ensures optimal film feed. In a cutting unit 108, the labels are precisely cut while a computer and Servo motor provide an exact cutoff point.

The labels 10 then proceed to a hotmelt unit 110, where glue is applied. For example, two narrows strips of hot melt glue may be applied to the labels 10. These strips are applied by a heated glue roller 110 to leading and trailing label edges. The label 10 with the glue strip on its leading edge is then transferred to an article 28 at the article table 112. This glue strip ensures an exact label positioning and a positive bond. As the article is rotated during label transfer, labels are applied tightly. Gluing of the trailing edge ensures proper bonding. Once the label 10 is applied, the article is discharged via a discharge starwheel 114. Operation of the above process (and optimization of the process parameters) may be controlled via a control cabinet 116.

Regardless of whether the film of the label is a shrink film or a nonshrink film, the top and bottom ends of the container may be capped with plastic ends (as in the case of a metal container, such as a metal can).

As various changes could be made in the above-described aspects and exemplary embodiments without departing from the scope of the invention, it is intended that all matter contained in the above description shall be interpreted as illustrative and not in a limiting sense.

What is claimed is:

1. An insulating label, comprising:
a first layer, being a printable layer;
a second layer, being an insulating layer; and
a third layer, being an extruded lamination layer, and being disposed between said first layer and said second layer to operatively couple said first layer and said second layer.

2. The insulating label of claim 1, wherein said first layer further comprises paper or a polymer chosen from a shrink or nonshrink polymer.

3. The insulating label of claim 2, wherein said first layer is a polymer, and said polymer is chosen from polyester, polypropylene, polyethylene, polyvinyl chloride, oriented polystyrene, polyethylene terephthalate glycol, and oriented polypropylene.

4. The insulating label of claim 1, wherein said first layer includes first and second surfaces, and further comprising an adhesive coating on said second surface of said first layer.

5. The insulating label of claim 4, further comprising an ink layer adjacent said second side of said first layer.

6. The insulating label of claim 1, wherein said first layer includes a first side and a second side, and further comprising an ink layer adjacent said second side of said first layer.

7. The insulating label of claim 6, wherein the ink layer is reverse-printed adjacent said second side of said first layer.

8. The insulating label of claim 1, wherein said second layer further comprises material chosen from synthetic woven fibers, natural woven fibers, synthetic nonwoven fibers, natural nonwoven fibers, and foam material.

9. The insulating label of claim 8, wherein said second layer further comprises a spun nonwoven polypropylene.

10. The insulating label of claim 1, wherein each of the first layer and the second layer include first and second sides, and the third layer confronts the second side of said first layer, and the first side of said second layer.

11. The insulating label of claim 1, wherein said third layer further comprises a component chosen from a polymer blend of polyethylene and polypropylene, an adhesive, and an extrudate.

12. The insulating label of claim 11, wherein the polymer blend further comprises a titanium dioxide additive.

13. The insulating label of claim 1, wherein one or more of the first layer, second layer, and third layer is die cut.

14. An insulating label, comprising:
a first layer including a shrink polymer, the first layer being a printable layer; and
a second layer operatively coupled to the first layer and incorporating an expandable coating.

15. The insulating label of claim 14, wherein said polymer of said first layer is chosen from polyester, polypropylene, polyethylene, polyvinyl chloride, oriented polystyrene, polyethylene terephthalate glycol, and oriented polypropylene.

16. The insulating label of claim 14, said expandable coating being heat-activatable.

17. The insulating label of claim 16, wherein said expandable coating includes a composition comprising a binder resin and a solvent.

18. The insulating label of claim 17, wherein said binder resin is present in a range of about 50% (wt.) to about 80% (wt.) of said expandable coating, and said solvent is present in a range of up to about 20% (wt.) of said expandable coating.

19. The insulating label of claim 17, wherein said composition is associated with a plurality of microspheres.

20. The insulating label of claim 19, wherein said microspheres are present in a range of about 10% (wt.) to about 50% (wt.) of said expandable coating.

21. The insulating label of claim 19, wherein said microspheres encapsulate a gas.

22. The insulating label of claim 17, wherein said binder resin is chosen from acrylic binders, vinyl acrylic copolymer binders, vinyl acetate homopolymer binders, styrene acrylic binders, and phenoxy binders.

23. The insulating label of claim 17, wherein the solvent is chosen from distilled water and isopropanol.

24. The insulating label of claim 14, wherein one or more of the first layer and second layer is die cut.
